(19) United States
(12) Patent Application Publication
(10) Pub. No.: US 2026/0072772 A1
(43) Pub. Date: Mar. 12, 2026

(54) Erroneous Data Load Detection

(71) Applicant: Oracle International Corporation, Redwood Shores, CA (US)

(72) Inventors: Tim Gaumont, Mesa, AZ (US); Pathanjali Malay, Leawood, KS (US); Abhishek Kumar, Saint Augustine, FL (US)

(73) Assignee: Oracle International Corporation, Redwood Shores, CA (US)

(21) Appl. No.: 19/185,560

(22) Filed: Apr. 22, 2025

Related U.S. Application Data
(60) Provisional application No. 63/691,914, filed on Sep. 6, 2024.

(51) Int. Cl. G06F 11/07

(52) U.S. Cl. CPC G06F 11/076; G06F 11/0721

(57) ABSTRACT

Techniques for data intake that prevent corruption of data repositories with faulty data are disclosed. A data load may include individual values that are erroneous and individual values that are non-erroneous. A system uses a machine learning (ML) model trained to classify the data load, as a whole, as erroneous or non-erroneous. In a data intake process, the system applies the ML model to the data load. In response to determining that the data load is erroneous, the system prevents the storage of the data load within a target data repository.

### BENEFIT CLAIMS; RELATED APPLICATIONS; INCORPORATION BY REFERENCE

This application claims the benefit of U.S. Provisional Patent Application 63/691,914, filed Sep. 6, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to managing the storage of data loads in data repositories.

### BACKGROUND

Database systems manage large amounts of information from a variety of sources. When faulty information is introduced into a database system, the faults may propagate within the system. For example, a user may upload a data set for one period of time that is mistakenly identified as being associated with another period of time. Subsequently, a database query may join the faulty data set with other data sets based on the incorrect time period. Thereafter, the fault may be carried forward into other records, reports, analytics, and workflows. As such, faulty information in a database is difficult and costly to correct after the faults are introduced.

The approaches described in this section are approaches that could be pursued, but not necessarily approaches that have been previously conceived or pursued. Therefore, unless otherwise indicated, one should not assume that any of the approaches described in this section qualify as prior art merely by virtue of inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates a functional block diagram of an example data management architecture in accordance with one or more embodiments;

FIG. 1B illustrates a system block diagram of an example data management system in accordance with one or more embodiments;

FIGS. 2A and 2B illustrate a process flow block diagram of an example set of operations for managing data in accordance with one or more embodiments;

FIGS. 3A and 3B illustrate functional flow block diagrams of example sets of operations for managing data in accordance with one or more embodiments;

FIGS. 4A, 4B, 4C, 4D, 4E, 4F, 4G, and 4H illustrate example data structures including data in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. PRACTICAL APPLICATIONS, ADVANTAGES & IMPROVEMENTS
3. ERRONEOUS DATA LOAD DETECTION ARCHITECTURE
4. DATA MANAGEMENT SYSTEM ARCHITECTURE
5. DETECTING ERRONEOUS DATA LOADS
6. EXAMPLES OF DETECTING ERRONEOUS DATA LOADS
7. HARDWARE OVERVIEW
8. MISCELLANEOUS; EXTENSIONS

### 1. General Overview

As referred to herein, a data load is a set of records or other data items that are transmitted as a batch. Individual records or data items in the same data load may have normal, non-anomalous values and outlier, anomalous values. Outlier values may, for example, result from an anomalous event, mistake, mishap, or unusual trend. Separate from individual values being erroneous or non-erroneous, a data load as a whole may be erroneous or non-erroneous. In an example, a user may attempt to upload a data load, corresponding to a second fiscal quarter for a company, as the data for the fourth fiscal quarter for the company. In this case, the individual values may be correct and non-erroneous, however, the data load, as a whole, is erroneous.

One or more embodiments determine that a data load, as a whole, is erroneous or non-erroneous. The system applies a machine learning (ML) model trained to classify a data load as erroneous or non-erroneous. The ML model may classify a data load as erroneous even though some individual records or data items within the data load may be normal, non-anomalous, and non-erroneous. Furthermore, the ML model may classify a data load as non-erroneous even though some individual records or data items within the data load may be outliers, anomalous, and erroneous.

The system applies the ML model to the data load prior to storing or committing the data load in a target data repository that stores data loads that have been classified as non-erroneous. In response to determining that the data load is erroneous or likely erroneous, the system prevents the storage of the data load in the target data repository. Furthermore, the system may generate a notification indicating the prediction by the ML model.

One or more embodiments train the ML model to classify a data load as erroneous or as likely erroneous based on a statistical relationship(s) between the data load and previous data loads. The statistical relationships are based on a comparison of representative values that represent the data load. The representative values (a) may be computed as a function of the individual values of the data load and (b) are not necessarily present within the data load itself. In a non-limiting example, the ML model is trained using training data sets, where a training data set includes representations of (a) a training data load corresponding to a first time period, (b) statistics corresponding to relationships between the training data load and reference data loads that correspond to time periods prior to the first time period, and (c) an indication of whether the training data load is erroneous or non-erroneous. The system then applies the trained ML model to representations of a target data load and/or statistics representing the relationship of the target data load and corresponding prior data loads. The trained ML model outputs an indication that the target data load is erroneous or likely erroneous.

One or more embodiments train an ML model to classify a data load as erroneous or likely erroneous based on previous data loads having similar characteristics as the data load. In another non-limiting example, the ML model is trained using training data sets, where a training data set includes representations of (a) a training data load corresponding to a first time period, (b) reference data loads corresponding to time periods prior to the first time period, and (c) an indication of whether the data load is erroneous or non-erroneous. The system then applies the trained ML model to representations of the target data load and prior data loads. The trained ML model outputs an indication that the target data load is erroneous and/or likely erroneous. The trained ML model may indicate a likelihood (e.g., as a percentage) of the data load being erroneous.

One or more embodiments described in this Specification and/or recited in the claims may not be included in this General Overview section.

### 2. Practical Applications, Advantages & Improvements

As described above and detailed below, example computing systems in accordance with the present disclosure enhance the technology of data storage systems by preventing the intake of erroneous data loads. In comparison to systems that identify faulty data sets that verify all items in a data set for anomalies, the example systems determine if a data load, as a whole, is erroneous. By detecting erroneous data loads as a whole, example systems more efficiently prevent storage of anomalous records or data items than by verifying individual records or data items. Additionally, the example systems avoid the corruption of data structures, processes, applications, and services that rely on data storage systems to provide accurate data. Furthermore, the example systems avoid the loss of data and processing time involved in identifying, tracing, and removing faulty data after a data load has been stored and propagated within data storage systems. Moreover, the example systems may be applied to detect and screen out data loads modified to include malicious information before storing the malicious information in a data storage system.

### 3. Erroneous Data Load Detection Architecture

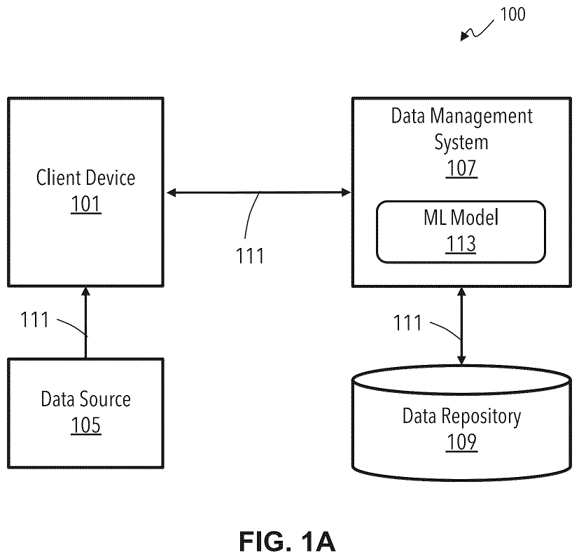

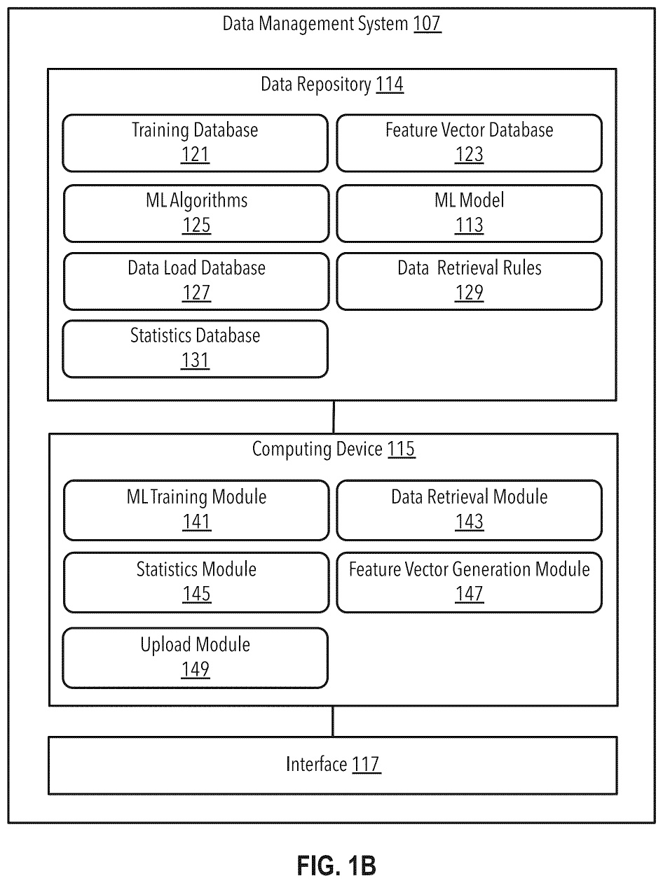

FIG. 1A illustrates a system architecture 100 in accordance with one or more embodiments. The architecture 100 includes a client device 101, a data source 105, a data management system 107, and a data repository 109 that are communicatively connected, directly or indirectly, via one or more communication links 111. In one or more embodiments, the architecture 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component. For example, the operations or components of the client device 101 or the data repository 109 can be combined into the data management system 107.

Embodiments of the architecture 100 manage the batch uploading of a data load from the data source 105 to the data repository 109 by the client device 101 using the data management system 107. The client device 101 comprises a computing system communicatively linked with the data source 105 and the data management system 107. The client device 101 may be a personal computer, workstation, server, mobile device, mobile phone, tablet device, and/or other processing device capable of implementing and/or executing software, applications, etc. A user of the client device 101 can be any individual, such as a computer scientist, an engineer, a software developer, a cybersecurity specialist, a system administrator, an information technology specialist, a data analyst, a financial analyst, a researcher, a business analyst, a project manager, a statistician, a consultant, etc. One or more embodiments of the client device 101 execute a computer-user interface allowing a user to access, perceive, and interact with the client device 101, data source 105, and the data management system 107. Depending on the implementation, the client device may function as a workstation or a web-based interface, enabling remote access and interaction with the data management system 107. For example, the client device 101 may execute software, such as a Web browser or client application, that generates the graphic user interface (GUI) for computer-user interface that the user interacts with to obtain data from the data source 105 and transmit a data load to the data management system 107 for storage in the data repository 109.

The data source 105 includes devices, software, and combinations thereof that generate and/or store data. Example data generation devices include system monitors, sensors, transducers, network devices, backend systems, medical diagnostic equipment, manufacturing controllers, point-of-sale terminals, and environmental monitoring instruments. Example data generation software includes network management software, data analysis software, logistic software, customer relationship management software, enterprise resource planning systems, cybersecurity threat detection tools, telemetry logging tools, financial transaction platforms, and user activity tracking applications. The data source 105 may output data continuously, periodically, or on-demand in various formats. The data may be output as, for example, JSON documents, XML files, CSV files, database snapshots, or serialized binary records. In some embodiments, the data source communicates with the client device 101 using message queues, RESTful APIs, file transfers, or publish-subscribe mechanisms.

The data management system 107 includes one or more computing devices that manage the storage and retrieval of data in the data repository 109. For example, the data management system 107 may comprise a database management system that manages a database stored in the data repository 109. As detailed below, managing the storage of data includes receiving a data load from the client device 101, verifying the data load, and uploading the data load to the data repository 109.

The data management system 107 verifies data loads using an ML model 113. Some embodiments of the ML model 113 are trained using training data sets, where a training data set includes representations of (a) a data load corresponding to a first time period, (b) statistics representing relationships between the data load and corresponding data loads from prior time periods that have similar characteristics to the first time period, and (c) an indication of whether the data load is erroneous or non-erroneous. The data management system 107 applies the trained ML model to representations of a target data load and statistics corresponding to the relationship of the target data load to data loads from prior time periods. Other embodiments of the ML model 113 are trained using training data sets, where a training data set includes representations of (a) a data load corresponding to a first time period, (b) data loads from corresponding prior time periods, and (c) an indication of whether the data load is erroneous or non-erroneous. The data management system 107 applies the trained ML model to representations of the target data load and data loads from prior time periods. In both embodiments, the trained ML model outputs the likelihood of the current data load being an erroneous data load. Additionally, or alternatively, the trained ML model outputs a prediction of the current data load being an erroneous data load or a non-erroneous data load.

The communication links 111 include wired and/or wireless information communication channels, such as the Internet, an intranet, an Ethernet network, a wireline network, a wireless network, a mobile communications network, and/or another communication network. For example, the client device 101 may communicate with the data management system 107 via the Internet by exchanging data packets through a Wi-Fi or cellular data network connection.

The data repository 109 is any type of storage unit and/or device (e.g., a file system, database, collection of tables, or any other storage mechanism) for storing data. Furthermore, the data repository 109 may include multiple different storage units and/or devices. The multiple different storage units and/or devices may or may not be of the same type or located at the same physical site. Furthermore, a data repository 109 may be implemented or executed on the same computing system as the data management system 107. The data repository 109 may be communicatively coupled to the architecture 100 via a direct connection or via a network. Data sets illustrated within data repository 109 may be implemented across any components within the architecture 100. However, these data sets are illustrated within the data repository 104 for purposes of clarity and explanation.

### 4. Data Management System Architecture

FIG. 1B is a block diagram illustrating example data management system 107 in accordance with one or more embodiments. The data management system 107 includes hardware and software that perform processes and functions described herein. In one or more embodiments, the data management system 107 includes more or fewer components than the components illustrated in FIG. 1B. The components illustrated in FIG. 1B can be local to or remote from each other. The components illustrated in FIG. 1B can be implemented in software and/or hardware. Components can be distributed over multiple applications and/or machines. Multiple components can be combined into one application and/or machine. Operations described with respect to one component can instead be performed by another component.

One or more embodiments of the data management system 107 include a data repository 114 and a computing device 115. The data repository 114 includes any type of storage unit and/or device (e.g., a file system, database, collection of tables, or other storage mechanism) for storing data. Furthermore, the data repository 114 may include multiple different storage units and/or devices. The multiple different storage units and/or devices may or may not be of the same type or located at the same physical site. Furthermore, the data repository 114 can be implemented or executed on the same computing system as the data management system 107. Additionally, or alternatively, the data repository 114 may be implemented or executed on a computing system separate from the data management system 107. The data repository 114 can be communicatively coupled, wired and/or wirelessly, to the data management system 107 via a direct connection or via a network.

The data repository 114 stores a training database 121, a feature vector database 123, ML algorithms 125, ML model 113, data load database 127, data retrieval rules 129, and statistics database 131. The training database 121 comprises one or more data structures that stores sets of training data for training the ML model 113. A training data set includes representations of (a) a first data load corresponding to a first time period, (b) statistics corresponding to relationships between the first data load and data loads of prior time periods that have similar characteristics to the first time period, and (c) an indication of whether the first data load is erroneous or non-erroneous. Additionally, or alternatively, a training data set includes representations of (a) a first data load corresponding to data associated with a first time period, (b) data loads of prior time periods that have similar characteristics to the first time period, and (c) an indication of whether the first data load is erroneous or non-erroneous. For example, the first data load can include a set of monthly server utilization data for a current year, and the similar data loads can include sets of monthly server utilization data from several past years.

The feature vector database 123 comprises one or more data structures that store feature vectors corresponding to the training data sets in the training database 121 and/or data loads stored in the data load database 127. A feature vector is a one-dimensional array of numerical or categorical values including individual values representing a quantifiable attribute or characteristic of a data instance extracted from the training data and/or data loads. For example, in a system that monitors annual server utilization, individual feature vectors include attributes representing a server's utilization over a current year and statistics corresponding to relationships between the current year and server utilization in prior years.

The ML algorithms 125 are one or more algorithms that iteratively train the ML model 113 to map a set of input variables to an output variable. More specifically, the ML algorithms 125 are configured to train the ML model 113 to classify a data load, as a whole, as erroneous or non-erroneous. An ML algorithm may be iterated to train a target model f that best maps a set of input variables to an output variable using the training data. The training data includes data sets and associated labels. The data sets are associated with input variables for the target model f. The associated labels are associated with the output variable of the target model f. The training data may be updated based on, for example, feedback on the predictions by the target model f and accuracy of the current target model f. Updated training data is fed back into the ML algorithm that, in turn, updates the target model f.

An ML algorithm generates a target model f such that the target model f best fits the data sets of training data to the labels of the training data. Additionally, or alternatively, a ML algorithm generates a target model f such that when the target model f is applied to the data sets of the training data, a maximum number of results determined by the target model f matches the labels of the training data. Different target models may be generated based on different ML algorithms and/or different sets of training data.

An ML algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

The ML model 113 is software trained using an ML algorithm to make predictions, recognize patterns, or perform tasks using a previously unseen data set without being explicitly programmed for specific decisions. During training, the ML algorithm is optimized to find certain patterns or outputs from the data set, depending on the task. The ML models 113 includes, for example, a supervised ML model trained using the training data to identify a data load, as a whole, as an erroneous data load or as a non-erroneous data load. Additionally, or alternatively, the ML model 113 determines a likelihood of the data load being an erroneous data load.

The data load database 127 includes one or more data structures that store target data loads and prior data loads. A target data load (also referred to herein as a “current data load”) includes sets of data being uploaded into a data repository, such as data repository 109. For example, the target data load may be a set of records uploaded as a batch into a database. The prior data loads comprise sets of data that were previously stored by the data management system 107 and retrieved to verify the target data load. A data load includes a set of values for a particular time period. The data load may include a range of values including both normal values (non-anomalous values) and outlier values (anomalous values). Outlier values may result from, for example, a rare event, an error, or an unusual trend. Outlier values are not necessarily indicative of any errors, as they may accurately represent an unusual event or trend.

The data retrieval rules 129 include one or more data structures storing a library of rules for generating queries that retrieve prior data loads. The rule library can include logical and heuristic rules. Logical rules are deterministic based on defined contexts. Heuristic rules are inference-based, using past behavior, similarity measures, or metadata patterns to suggest relevant rules even when an exact match is not present. When a target data load is submitted, the system extracts its context metadata and performs a lookup in this rule library to identify a rule that best matches the context of the data load. An example rule library includes predefined rules indexed by respective context parameters of the rules. Entries in the library may be indexes by a time frame, time segments, and types of data. Individual entries include one or more rules detailing query parameters for retrieving prior data loads, such as the historical time frame to retrieve, the aggregation method to use, and any necessary data transformation logic.

The statistics database 131 includes one or more data structures storing representative values representing a target data load and corresponding prior data loads. Example representative values may include a mode, mean, total, range, and standard deviation of the anomalous and/or non-anomalous values in a data load. Additionally, the statistics database 131 may store values representing relationships between the target data load and corresponding prior data loads. The relationships may be statistical values indicating a pattern or trend between the representative values.

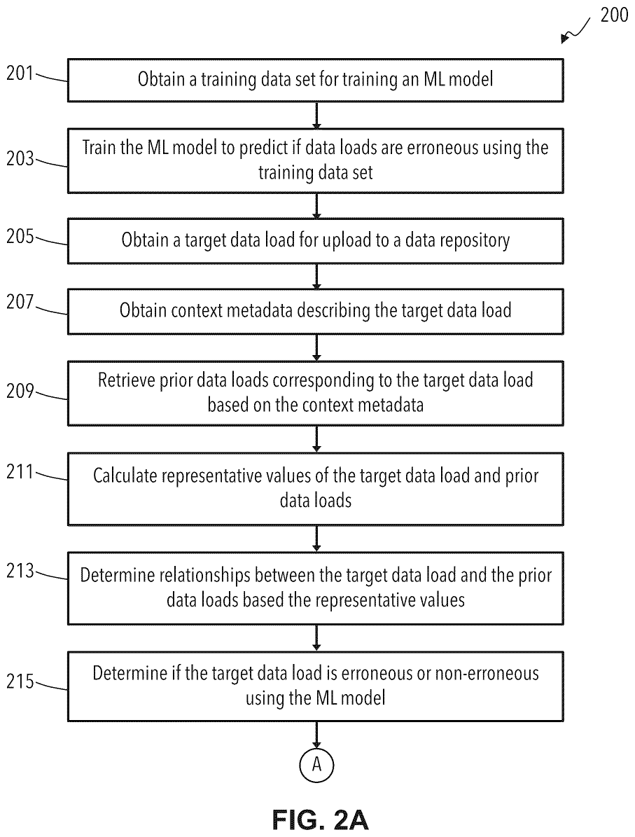

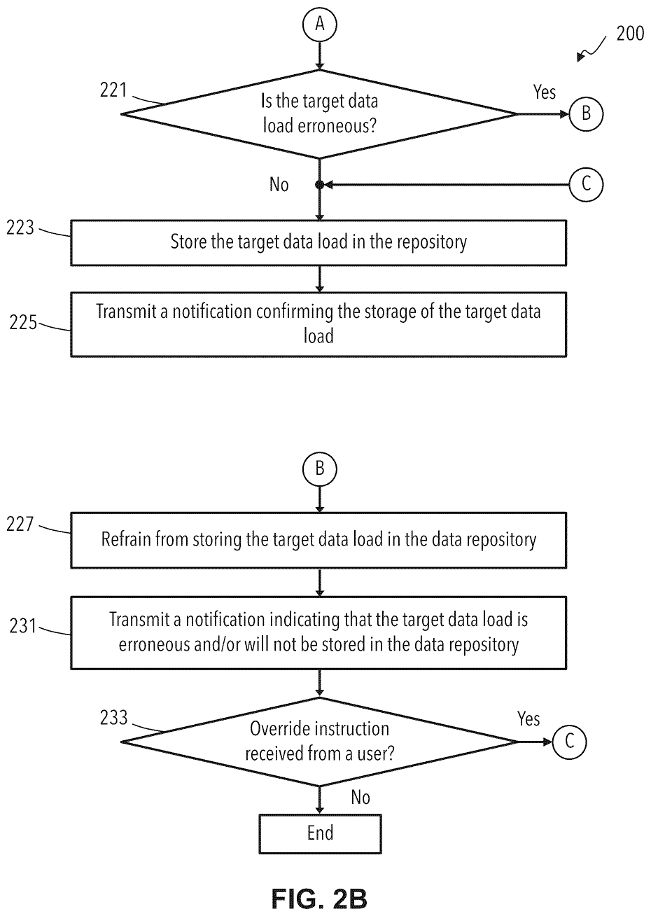

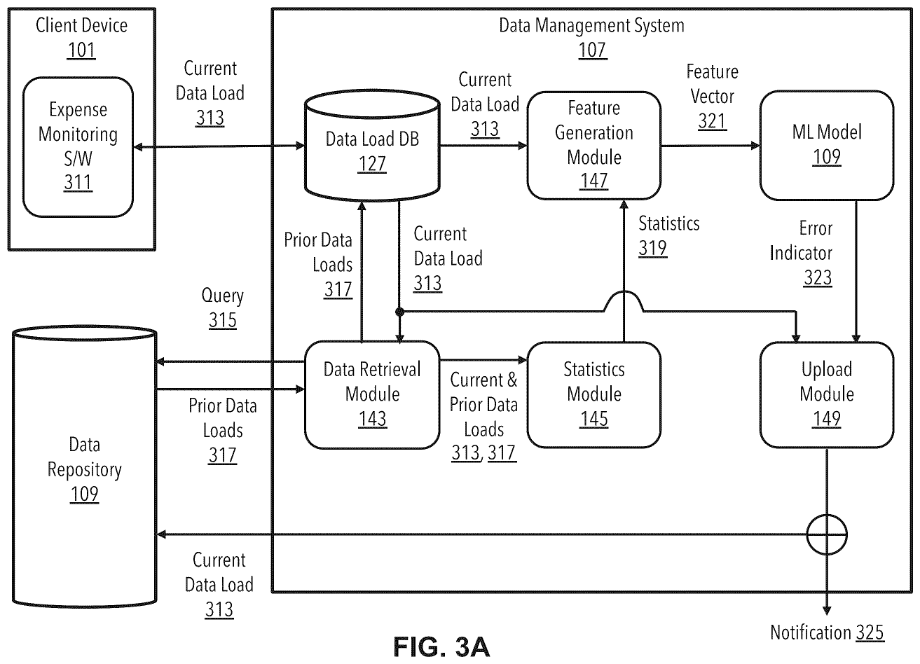

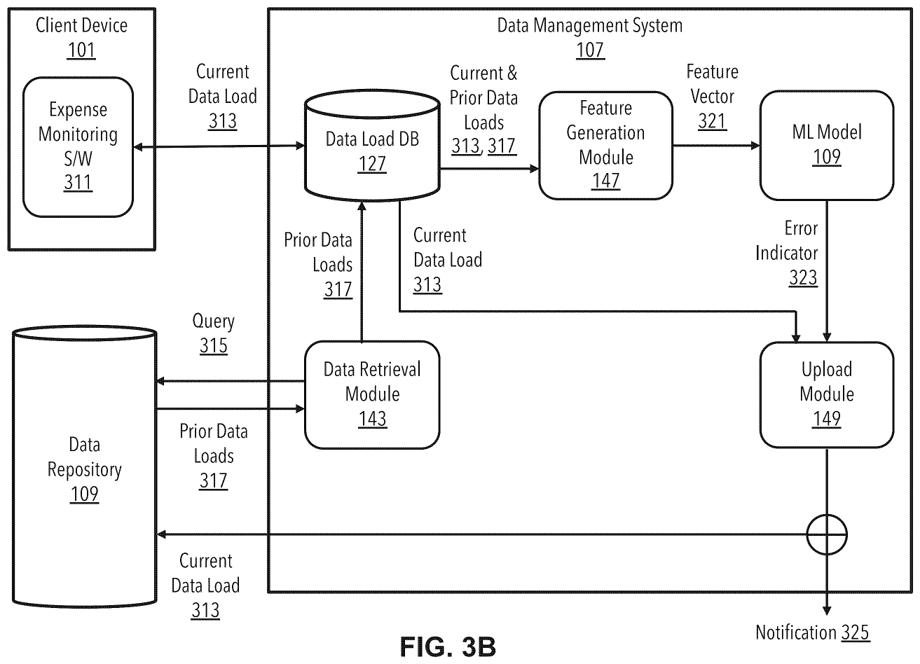

In one or more embodiments, the computing device 115 includes hardware and/or software configured to perform operations described herein. Example operations are described below with reference to FIGS. 2A, 2B, 3A, and 3B. The computing device 115 executes computer-readable program instructions, such as an operating system and application programs, that are stored in memory devices and/or the storage system. Additionally, the computing device 115 executes program instructions of an ML training module 141, a data retrieval module 143, a statistics module 145, a feature vector generation module 147, and an upload module 149.

The ML training module 141 executes an ML algorithm to train the ML model 113. For example, the ML training module 141 may retrieve training data from the training database 121 and convert the training data to computer-readable feature vectors optimized for the ML algorithms and/or the ML models 113. Using the feature vectors and the ML algorithms, the ML training module 141 trains the ML model 113 to identify a data load, as a whole, as an erroneous data load or as a non-erroneous data load.

The data retrieval module 143 retrieves prior data loads corresponding to a target data load. For a particular data load, data retrieval module 143 extracts metadata describing the context of the data load. The context metadata may include various descriptors, such as the type of data, the associated time frame, and the data type (e.g., server utilization). Using the context metadata, data retrieval module 143 identifies an appropriate rule for retrieving prior data loads corresponding to input data load. For example, data retrieval module 143 may compare the metadata of the data load to metadata corresponding to the rules in the data retrieval rules 129 (e.g., monthly server utilization). After identifying a matching rule, the data retrieval module 143 uses the rule to define the parameters for a database query specifying prior data loads to retrieve. For example, if the target data load is “monthly server utilization data for 2024,” the context includes the content type “server utilization,” a time frame of “yearly,” and a time segment of “monthly. ” Based on these attributes, the data retrieval module may identify a rule specifying that for monthly server utilization reports, the system should retrieve data from the previous five years.

The statistics module 145 calculates statistics representing data loads and, based on the statistics, determines relationships between the data loads, and store the statistics in the statistics database 131. These relationships are determined using statistical computations that characterize differences, trends, or anomalies. The statistics module 145 receives the target data load and a set of corresponding prior data loads and applies a set of predefined statistical algorithms to compute comparative statistics, such as a mode, mean, total, minimum, maximum range, and standard deviation. In addition to these descriptive statistics, the statistics module 145 may compute percentage changes, moving averages, and year-over-year comparisons to capture temporal aspects. For example, if the target data load includes annual server utilization values for the year 2024, the statistics module 145 may analyze corresponding data loads for years 2023, 2022, and 2021. The statistics module 145 might calculate the mean utilization value for the prior periods and compare the value to the current period's value. The statistics module 145 might also compute the total annual value and the minimum/maximum values.

The feature vector generation module 147 generates feature vectors for application to the ML algorithms 125 and ML model 113. For example, the feature vector generation module 147 can generate feature vectors by extracting attributes from a data load and statistics, and storing the feature vectors in the feature vector database 123. A feature vector is a one-dimensional array, including elements that represent a specific attribute or measurement relevant to the ML task. These attributes may include raw values from the data load, such as average server utilization for a given month, as well as computed metrics like percentage change from a previous year. The module may also include temporal context, such as month identifiers, year-over-year trends, or usage category labels derived from metadata.

The upload module 149 determines whether or not to store a data load in the data repository 109 based on the output of the ML model 113. Storing the data load may involve uploading and committing the data load to a database. In addition to storing valid data load, the upload module 149 generates and transmits system notifications to users or downstream systems indicating if the data load was successfully stored. The notification can be delivered to the client device 101 through a GUI, an email alert, or a message sent via an application programming interface (API). This allows users to take corrective actions when needed, such as reviewing and correcting a rejected data load.

### 5. Detecting Erroneous Data Loads

FIGS. 2A and 2B illustrate an example sets of operations for the architecture 100 in accordance with one or more embodiments. One or more operations illustrated in FIGS. 2A and 2B may be modified, rearranged, or omitted. Accordingly, the particular sequence of operations illustrated in FIGS. 2A and 2B should not be construed as limiting the scope of one or more embodiments.

The operations illustrated in FIGS. 2A and 2B show a process 200 for detecting erroneous data loads using an ML model to prevent storage of anomalous data in a data repository. The system obtains training data sets for training the ML model to identify erroneous data loads (Operation 201). The system may retrieve the training data sets from a data source that is directly or indirectly connected to the system via a communications link. In some embodiments, the training data sets include the following: a training data load that includes data associated with a first time period; statistics corresponding to relationships between the training data load and historical data loads from prior time periods that have similar characteristics to the first time period; and a label indicating if the training data load is erroneous or non-erroneous. In some other embodiments, the training data sets include a training data load including data associated with the first time period, historical data loads from prior time periods that have similar characteristics to the first time period, and a label indicating whether or not the training data load is erroneous.

The system trains the ML model to predict whether data loads are erroneous or not using the training data sets (Operation 203). In some embodiments, training the ML model includes training a neural network to process one or more feature vectors that represent the target data load and statistics representing the relationship of the target data load with prior data loads. In other embodiments, training the ML model includes training a neural network to process one or more feature vectors that represent the target data load and prior data loads.

During the training operations, the system evaluates and adjusts the ML model by measuring the accuracy of the ML model's predictions against the labels in the training data (e.g., erroneous or non-erroneous). Once the ML model is trained, the system verifies the ML model using a subset of the training data to determine if the output is sufficiently accurate (e.g., ≥95% accurate). The verification may include comparing the classification of erroneous or non-erroneous output by the ML model to the known outputs in the verification data. The system uses a loss function, such as Binary Cross-Entropy Loss, Weighted Binary Cross-Entropy, or Focal Loss, to compare the ML model's predictions against the known outcomes and uses the results to adjust the model.

The system applies the ML model to predict whether a previously unseen data load is erroneous or non-erroneous. The system obtains a target data load for storage in a data repository (Operation 205). The data load comprises a batch of records or data items that may include anomalous and/or non-anomalous information. The system may receive the target data load from a client as part of an intake operation that transfers the records or data items from a data source to a data repository. For example, the system may receive the target data load from a remote network management system via an upload operation initiated by a user via a user interface of a client device. The system may store the target data load in temporary storage for evaluation and error detection as described herein.

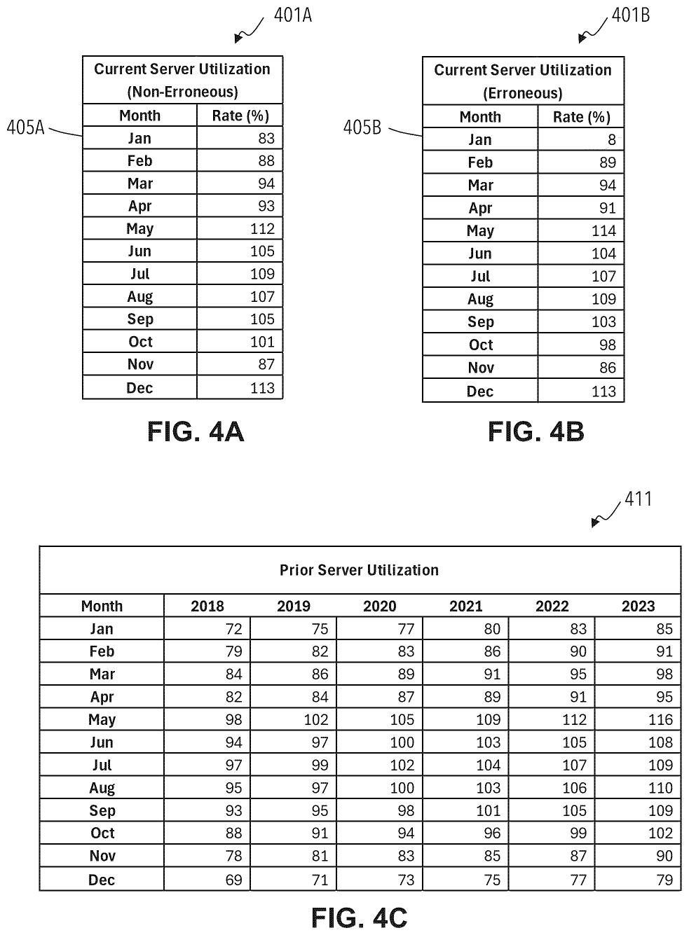

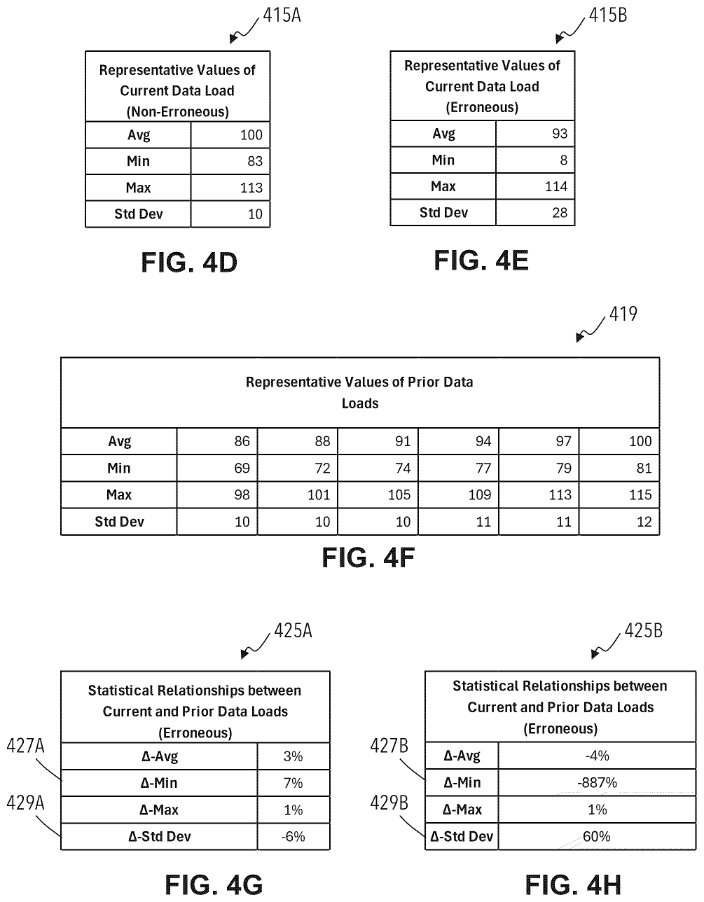

The system obtains context metadata describing the target data load (Operation 207). Example context metadata describes the time period of the data load (e.g., a day, month, quarter, year, or a combination thereof), the category of the data load (e.g., network data), the content of the data in the load (e.g., server utilization), the time segments of the data in the data load (e.g., monthly), and/or the type of data in the data load (e.g., rates). The system may receive the context metadata in association with the target data load. For example, the system may receive pre-established context metadata in the target data load or in an associated file (e.g., JSON or XML descriptors). Additionally, or alternatively, the system may extract the metadata from the content of the target data load. The system may apply pattern recognition, natural language processing, or rule-based parsing techniques to extract the metadata based on the title, column headers, and contents of the data load. For instance, as illustrated in FIG. 4A, target data load 401A comprises a table named “Current Server Utilization.” Based on the table name, the system can infer that the time period is the current year, the domain is “network data,” and the content type is “server utilization.” Additionally, based on the first row of a table including column labels, such as “Month” and “Rate (%),” the system may infer that the data segments are “monthly,” and the metrics are “rates.”

The system retrieves prior data loads corresponding to the target data load based on the context metadata of the target load (Operation 209). The system may use the context metadata to query a database and retrieve tables corresponding to the metadata. The system applies one or more rules to determine parameters of a query to retrieve the prior data loads corresponding to the target data load based on the context metadata. The system may obtain the rule from a library of data retrieval rules indexed by respective context parameters. Determining the rule corresponding to the target data set involves matching the context metadata to the respective context parameters defined for the rules. Additionally, or alternatively, the system may use a scoring mechanism to determine similarity values indicating a closeness of matches and selects a rule that best matches the context metadata of the target data load. For example, if the target data load includes monthly server utilization data for the current year, the system may identify and apply a rule that generates a query to retrieve prior data loads for monthly server utilization data for the three preceding years. In another example, if the target data load contains server utilization data for the current month, the system may apply a rule that extracts both the month and the year from the target data load and then generates a query to retrieve server utilization data for that same month over the previous three years.

The system calculates representative values of the content of the target data load and the prior data loads (Operation 211). The statistics may be determined by applying statistical functions or algorithms to the individual values or groups of values in the data loads. As an example, the statistics may include a total value, an average value, a mode value, a standard deviation, a range, a minimum value, and/or a maximum value. Accordingly, the value represents a data load as a whole rather than individual values of the data load. In a non-limiting example, FIG. 4A illustrates a table representing a current data load 401A that includes monthly server utilization rates for a current year. FIG. 4C illustrates a table representing prior data loads 411 corresponding to the category, time frame, and time segments of the current data load 401A. In particular, the prior data loads 411 include monthly server utilization rates for several years prior to the current year. Using the current data load 401A and the prior data loads 411, the system calculates statistics representing the data loads as a whole. In the present example, the statistics include averages of the data values over the years, the minimum/maximum values for the years, and a standard deviation over the years. For example, FIG. 4D illustrates a table including statistics representing the current data load 401A. FIG. 4F illustrates a table including corresponding statistics representing the prior data loads 411.

The system determines one or more relationships between the target data load and the prior data loads based on the representative values (Operation 213). The relationships may be statistical values indicating a pattern or trend between the representative values. For example, FIG. 4G illustrates a table of values representing relationships between the statics in FIG. 4D and the statistics in FIG. 4F. More specifically, the system calculates a difference between the statistics determined for the current data load (e.g., FIG. 4D) and the statistics of the three most recent years (e.g., a 3-year moving average) determined for the prior data loads (e.g., FIG. 4F).

The system determines if the target data load is erroneous or non-erroneous using the ML model (Operation 215). In some embodiments, the system applies the ML model to the target data load and the statistics to predict whether the target data load is erroneous or non-erroneous or to predict a likelihood of the target data load being erroneous. The statistics applied to the ML model may be the values indicating the relationships between the target data load and the prior data loads (e.g., FIG. 4G). Additionally, or alternatively, the statistics applied to the ML model may be the representative values of the target data load (e.g., FIG. 4D) and the representative values of the prior data loads (e.g., FIG. 4F). In some other embodiments, the system applies the trained ML model to the target data load (e.g., FIG. 4A) and the prior data loads (e.g., FIG. 4C) to predict whether the target data load is erroneous or non-erroneous or to predict a likelihood of the target data load being erroneous. Applying the trained ML model may include converting the data loads and statistics to feature vectors and applying the ML model to the feature vectors. In response to applying the ML learning model, the system receives an output that indicates whether the target data load is erroneous load or a non-erroneous.

Continuing to FIG. 2B, as indicated by off-page connector “A”, the system determines if the target data load is erroneous by analyzing the output of the ML model. The output may be a binary classification result, where the ML model produces a value such as ‘0’ for “non-erroneous” and ‘1’ for “erroneous.” The binary output allows the system to make a direct decision without further analysis. Additionally, or alternatively, the ML model produces a probability or confidence score that reflects the likelihood that the data load is erroneous. The system then compares this score to a predetermined threshold. If the score exceeds the threshold, the system flags the data load as potentially erroneous. For example, if the ML model outputs a confidence score of 0.85 that a particular monthly server utilization report is erroneous, and the system's threshold is 0.80, then the system indicates the data load as erroneous. The threshold value used for this decision may be static (e.g., predefined) or dynamic (variable based on feedback). In some cases, the system may also support multiple threshold levels for different actions. For example, a lower threshold might trigger a warning, while a higher threshold might automatically block intake of the target data load.

The system manages the storage of a target data load based on whether the data has been identified as erroneous or non-erroneous. The system determines if the target data load is erroneous (Operation 221). If the system determines that the target data load is not erroneous at then the system stores the target data load in the data repository (Operation 223). Storing the data may involve uploading and/or committing the data load to a database. After successfully storing the target data load, the system may generate and transmit a notification to the user (Operation 225). This notification can be delivered to the client device via email, a messaging, or a user interface. On the other hand, if the system determines that the target data load is erroneous, the system refrains from storing the data in the repository (Operation 227). Refraining from storing may include terminating the data intake process without committing the information in the target data load to the database.

The system transmits a notification indicating that the target data load is erroneous and will not be stored in the data repository (Operation 231). The system may transmit the notification to a user at the client device. The notification may indicate why the data load was flagged. The notification may also include a prompt or interface element allowing the user to submit an override command. For example, the user may override the denial when the data load accurately represents an atypical event. If the system receives an override command (e.g., Operation 233), the system resumes the original storage process and stores the target data load in the repository (returning to Operation 223). If no override is received (e.g., Operation 233) within a pre-established window of time, the process ends without saving the data.

### 6. Examples of Detecting Erroneous Data Loads

FIG. 3A illustrates a functional flow block diagram of a non-limiting example for verifying data loads using an embodiment of the ML model 113 trained based on statistics representing relationships between a target data load and corresponding data loads from prior time periods. Initially, a user of client device 101 can execute network monitoring software 311 that generates analytic information for a network. Using the client device 101, the user attempts to upload a current data load 313 that includes server utilization records for the current year to the data repository 109 via the data management system 107. The data management system 107 receives the current data load 313 from the client device 101 and stores the current data load 313 in the data load database 127 for verification prior to completing the upload process.

The data management system 107 processes the current data load 313 to determine statistics based on corresponding prior data loads 317. Determining the statistics includes data retrieval module 143 determining context metadata of the current data load 313 to retrieve corresponding prior data loads 317. In some instances, the current data load 313 includes or is associated with metadata describing its context. For example, the current data load 313 may be associated with an XML file having key value pairs, such as time frame: “year,” time segments: “monthly,” and data type: “server utilization.” In other instances, the data retrieval module 143 may extract the context metadata from the content of the current data load 313. For example, the data retrieval module 143 may determine the time frame, time segments, and data type from the file names and table headers of the current data load 313.

Using the context information of the current data load 313, the data retrieval module 143 identifies a rule for generating a query 315 to retrieve the prior data loads 317 corresponding to the current data load 313. Some embodiments of the data retrieval module 143 match the context metadata to respective context parameters of rules indexed in a rule library. For example, the system may match the “server utilization” and “annual” with a rule that indicates retrieving records for the past five years of “server analytics,” “utilization,” and “annual.” The data retrieval module 143 then submits the query 315 to the data repository 109 and, in response, receives the prior data loads 317 corresponding to the current data load 313.

The data retrieval module 143 transmits the current data load 313 and the prior data loads 317 to the statistics module 145. The data retrieval module 143 may also store the prior data loads 317 in association with current data load 313 in the data load database 127 for future reference. The statistics module 145 calculates representative values for the data loads 313 and 317 and, based on the representative values, determines relationships between the current data load 313 and the prior data loads 317. For example, as illustrated in FIG. 4G, the representative values 425A may include an average value, minimum/maximum values, and standard deviation that represent the data loads as a whole rather than as individual values. The statistics module 145 outputs statistics 319 based on a comparison of one or more representative values of the current data load 313 and the prior data loads 317 that indicate a relationship and/or a pattern between the data loads 313 and 317.

The feature vector generation module 147 uses the current data load 313 and the statistics 319 to generate a feature vector 321 for submission to the ML model 113. In accordance with the present example, the ML model 113 is trained to identify the current data load 313 as erroneous or non-erroneous based on the current data load 313 and the statistics 319. The ML model outputs error indicator of 323 that identifies the current data load 313 as erroneous or non-erroneous.

The upload module 149 uploads the current data load 313 to the data repository 109 based on the error indicator 323. If the error indicator 323 indicates that the current data load 313 is not erroneous, the upload module 149 proceeds to upload and commit the record to the data repository 109. If the error indicator 323 indicates the current data load 313 is erroneous, then the upload module 149 issues a notification 325 to the client 101 device indicating that the record will not be uploaded.

FIG. 3B illustrates a functional flow block diagram of a non-limiting example for verifying data loads use an embodiment of the ML model 113 trained based on relationships between a target data load and corresponding prior data loads from to prior time periods. In a same or similar manner to that described in FIG. 3A, the user of client device 101 attempts to upload a current data load 313 including server utilization records for the current year to the data repository 109 via to the data management system 107.

The data management system 107 processes the current data load 313 to obtain prior data loads 317 having contexts appropriate for the context of the current data load 313. The data retrieval module 143 obtains the prior data loads by determining context metadata of the current data load 313 to retrieve the corresponding prior data loads 317. As described above, the data retrieval module 143 obtains or extracts the context metadata for the current data load 313. Using the context information of the current data load 313, the data retrieval module 143 generates a query to retrieve the prior data loads 317.

Using the current data load 313 and the prior data loads 317, the feature vector generation module 147 generates a feature vector for submission to the ML model 113. In accordance with the present example, the ML model 113 is trained to identify the current data load 313 as erroneous or non-erroneous based on the current data load 313 and the prior data loads 317. The ML model 113 outputs an error indicator of 323, identifying the current data load 313 as erroneous or non-erroneous.

The upload module 149 uploads the current data load 313 to the daily repository 109 based on the error indicator 323. If the error indicator 323 indicates that the current data record is not erroneous, the upload module 149 uploads the current data load 313 to the data repository 109. If the error indicator 323 indicates the current data load 313 is erroneous, then the upload module 149 issues a notification to the claim device, indicating that the record will not be uploaded and refrains from uploading the current data load 313 as described above.

FIGS. 4A, 4B, 4C, 4D, 4E, 4F, 4G, and 4H illustrate example data structures showing tables for data loads in accordance with one or more embodiments. FIG. 4A illustrates an example current data load 401A. The current data load 401A comprises monthly server utilization rates for a current year. For the sake of example, the data load 401A represents a non-erroneous data load. For comparison, FIG. 4B illustrates an example current data load 401B. The current data load 401B is substantially similar to the current data load 401A. Differently, the data load 401B represents an erroneous data load including an anomalous data item 405B. That is, the rate of 8% for the data item 405B is an anomalous value substantially different from other values in the data load 401B. The anomalous value may be due to, for example, a data entry error, data corruption, or other fault. In comparison, data item 405A in data load 401A includes a non-anomalous value that is substantially similar to the other values in the data load 401A.

FIG. 4C illustrates an examples table of prior data loads 411 corresponding to the current data loads 401A and 401B. As detailed above, the prior data loads 411 may be retrieved from a data repository by a query generated based on context metadata of the current data loads 401A or 401B. For example, the current data loads 401A and 401B may be associated with the following context metadata included in, or extracted from, the current data loads 401A and 401B: time frame: “yearly,” time segments: “monthly,” and data type: “server utilization.”

FIGS. 4D, 4E, and 4F illustrate example tables that include representative values 415A, 415B, and 419 of the current data load 401A, current data load 401B, and prior data loads 411, respectively. The example representative values comprise statistics calculated from the content of the data loads 401A, 401B, and 411. In the present examples, the statistics include averages, minimum values, maximum values, and standard deviations of the respective values of the data loads 401A, 401B, and 411.

FIG. 4G illustrates an example table that includes statistical relationships 425A between representative values 415A of the non-erroneous current data load 401A and the representative values 419 of the prior data loads 411. For example, the statistical value 427A indicates a difference between the average value (Δ-Avg) of the current data load 401A and the average of the three most recent average values of the prior data loads. The statistical value 429A indicates a difference between the standard deviation of the current data load 401A and the standard deviation of the three most recent average values of the prior data loads 411.

For comparison, FIG. 4H illustrates an example statistical relationships 425B that includes statistical relationships between representative values 415B of the erroneous current data load 401B and the representative values 419 of the prior data loads 411. The statistical relationships 425B are substantially similar to the statistical relationships 425A. Differently than the statistical relationships 425A, the statistical values 427B and 429B of the statistical relationships 425B are substantially different than statistical values 427A and 429A of statistical relationships 425A. More specifically, the statistical values 427A and 429A have a difference of less than 10%. In contrast, the statistical values 427B and 429B have a difference of 60% and-887%, respectively.

As described above, an example system in accordance with one or more embodiments determines if the current data loads 401A and 401B are erroneous or non-erroneous by using a trained ML model (Operation 215). The system applies the ML model to the current data loads 401A and 401B and the statistical relationships 425A and 425B to predict whether the current data loads 401A and 401B are erroneous or non-erroneous. In some other embodiments, the system applies a trained ML model to the target data loads current data loads 401A and 401B and the prior data loads 411 to predict whether the current data loads 401A and 401B are erroneous or non-erroneous or to predict a likelihood of the target data load being erroneous.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

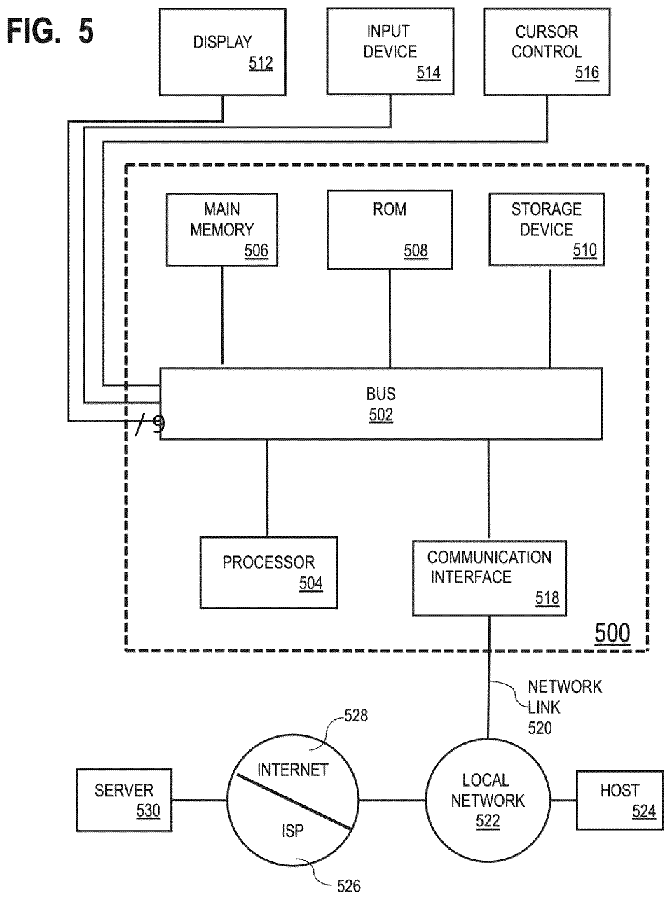

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518 that carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as the code is received, and/or stored in storage device 510, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions that, when executed by one or more hardware processors, cause performance of operations comprising:
obtaining training data sets for training a machine learning (ML) model to predict a likelihood of a first target data load being erroneous, the training data sets comprising: (a) a first data load corresponding to a first time period, (b) statistics corresponding to relationships between the first data load and data loads corresponding to time periods prior to the first time period, and (c) an indication of whether the first data load is erroneous or non-erroneous;
training the ML model based on the training data sets;
receiving the first target data load comprising data for a first time period via an upload operation, the first target data load including a set of records with anomalous and non-anomalous data points;
computing statistics for the first target data load based on relationships of the first target data load to the data loads associated with time periods prior to the first time period;
based at least on applying the ML model to the first target data load and the statistics for the first target data load to determine that the first target data load, including the set of records with anomalous and non-anomalous data points, is erroneous; and
responsive to determining that the first data load is erroneous, performing at least one of:
presenting a notification indicating that the first data load is erroneous;
terminating a data intake process for the first target data load; and
refraining from adding the first target data load to a data repository.

2. The one or more non-transitory computer readable media of claim 1, wherein the operations further comprise:
receiving a second target data load comprising data for a second time period via a second upload operation, the second target data load including a second set of records with anomalous and non-anomalous data points;
computing statistics for the second target data load based on relationships of the second target data load to data loads associated with time periods prior to the second time period;
based at least on applying the ML model to the second target data load and the statistics for the second target data load to determine that the second target data load, including the set of records with anomalous and non-anomalous data points, is not erroneous; and
responsive to determining that the second target data load is not erroneous, completing a second data intake process for the second target data load, wherein completing the second data intake process comprises intaking the second set of records with both the anomalous and non-anomalous data points.

3. The one or more non-transitory computer readable media of claim 2, wherein completing the intake process comprises storing the second target data load in the data repository.

4. The one or more non-transitory computer readable media of claim 1, wherein computing the statistics comprises:
calculating at least one first representative value using the content of the target data load;
calculating at least one second representative value using the content of the data loads corresponding to time periods prior to the first time period; and
determining one or more statistical relationships between the at least one first representative value and the at least one second representative value.

5. The one or more non-transitory computer readable media of claim 1, wherein determining that the first target data load is erroneous further comprises:
applying the ML model to the first target data load and the statistics for the first target data load to determine a likelihood that the first data load is erroneous,
wherein determining that the first data load is erroneous is based on the likelihood exceeding a threshold value.

6. The one or more non-transitory computer readable media of claim 1, wherein the operations further comprise:
determining context metadata of the first target data load, the context metadata comprising at least a category of data and the time period of the first target data load; and
retrieving the data loads corresponding to the time periods prior to the first time period using the context metadata.

7. The one or more non-transitory computer readable media of claim 1, wherein the operations further comprise, responsive to determining that the first data load is erroneous:
receiving an instruction from a user overriding the determination that the first data load is erroneous; and
proceeding with the upload operation of the first target data load.

8. A method comprising:
obtaining training data sets for training a machine learning (ML) model to predict a likelihood of a first target data load being erroneous, the training data sets comprising: (a) a first data load corresponding to a first time period, (b) statistics corresponding to relationships between the first data load and data loads corresponding to time periods prior to the first time period, and (c) an indication of whether the first data load is erroneous or non-erroneous;
training the ML model based on the training data sets;
receiving the first target data load comprising data for a first time period via an upload operation, the first target data load including a set of records with anomalous and non-anomalous data points;
computing statistics for the first target data load based on relationships of the first target data load to the data loads associated with time periods prior to the first time period;
based at least on applying the ML model to the first target data load and the statistics for the first target data load to determine that the first target data load, including the set of records with anomalous and non-anomalous data points, is erroneous; and
responsive to determining that the first data load is erroneous, performing at least one of:
presenting a notification indicating that the first data load is erroneous;
terminating a data intake process for the first target data load; and
refraining from adding the first target data load to a data repository,
wherein the method is performed by at least one device including a hardware processor.

9. The method of claim 8, further comprising:
receiving a second target data load comprising data for a second time period via a second upload operation, the second target data load including a second set of records with anomalous and non-anomalous data points;
computing statistics for the second target data load based on relationships of the second target data load to data loads associated with time periods prior to the second time period;
based at least on applying the ML model to the second target data load and the statistics for the second target data load to determine that the second target data load, including the set of records with anomalous and non-anomalous data points, is not erroneous; and
responsive to determining that the second target data load is not erroneous, completing a second data intake process for the second target data load, wherein completing the second data intake process comprises intaking the second set of records with both the anomalous and non-anomalous data points.

10. The method of claim 9, wherein completing the intake process comprises storing the second target data load in the data repository.

11. The method of claim 8, wherein computing the statistics comprises:
calculating at least one first representative value using the content of the target data load;
calculating at least one second representative value using the content of the data loads corresponding to time periods prior to the first time period; and
determining one or more statistical relationships between the at least one first representative value and the at least one second representative value.

12. The method of claim 8, wherein determining that the first target data load is erroneous further comprises:
applying the ML model to the first target data load and the statistics for the first target data load to determine a likelihood that the first data load is erroneous,
wherein determining that the first data load is erroneous is based on the likelihood exceeding a threshold value.

13. The method of claim 8, further comprising:
determining context metadata of the first target data load, the context metadata comprising at least a category of data and the time period of the first target data load; and
retrieving the data loads corresponding to the time periods prior to the first time period using the context metadata.

14. The method of claim 8, further comprising, responsive to determining that the first data load is erroneous:
receiving an instruction from a user overriding the determination that the first data load is erroneous; and
proceeding with the upload operation of the first target data load.

15. A system comprising:
at least one device including a hardware processor;
the system being configured to perform operations comprising:
obtaining training data sets for training a ML model to predict a likelihood of a first target data load being erroneous, the training data including: (a) a first data load corresponding to data associated with a first time period, (b) data loads corresponding to time periods prior to the first time period, and (c) an indication of whether the first data load is erroneous or non-erroneous;
training the ML model based on the training data sets;
receiving the first target data load comprising data for a first time period via an upload operation, the first target data load including a set of records with anomalous and non-anomalous data points;
based at least on applying the ML model to the first target data load and the data loads corresponding to the time periods prior to the first time period to determine that the first target data load, including the set of records with anomalous and non-anomalous data points, is erroneous; and
responsive to determining that the first data load is erroneous, performing at least one of:
presenting a notification indicating that the first data load is erroneous;
terminating a data intake process for the first target data load; and
refraining from adding the first target data load to a data repository.

16. The system of claim 15, wherein the operations further comprise:
receiving a second target data load comprising data for a second time period via a second upload operation, the second target data load including a second set of records with anomalous and non-anomalous data points;
based at least on applying the ML model to the second target data load and the data loads corresponding to respective time periods prior to the second time period to determine that the second target data load, including the set of records with anomalous and non-anomalous data points, is not erroneous; and
responsive to determining that the second target data load is not erroneous, completing a second data intake process for the second data load, wherein completing the second data intake process comprises intaking the second set of records with both the anomalous and non-anomalous data points.

17. The system of claim 16, wherein completing the second intake process comprises storing the second target data load in the data repository.

18. The system of claim 15, wherein, determining that the first target data load is erroneous further comprises:
applying the ML model to the first target data load and the data loads corresponding to the first target data load to determine a likelihood that the first data load is erroneous,
wherein determining that the first data load is erroneous is based on the likelihood exceeding a threshold value.

19. The system of claim 15, wherein the operations further comprise:
determining context metadata of the first target data load, the context metadata comprising at least a category of data and the time period of the first target data load; and
retrieving the data loads corresponding to the time periods prior to the first time period using the context metadata.

20. The system of claim 15, wherein the operations further comprise, responsive to determining that the first data load is erroneous:
receiving an instruction from a user overriding the determination that the first data load is erroneous; and
proceeding with the upload operation of the first target data load.
